(19) United States
(12) Patent Application Publication
(10) Pub. No.: US 2011/0112240 A1
(43) Pub. Date: May 12, 2011

(54) POLYCARBONATES HAVING IMPROVED TRANSMISSION

(75) Inventors: Berit Krauter, Neuss (DE); Michael Prein, Krefeld (DE)

(73) Assignee: Bayer MaterialScience AG, Leverkusen (DE)

(21) Appl. No.: 12/940,431

(22) Filed: Nov. 5, 2010

(30) Foreign Application Priority Data
Nov. 7, 2009 (DE) 102009052363.4

(51) Int. Cl. C08L 69/00; B29C 45/00

(52) U.S. Cl. 524/540; 525/534; 264/328.1

(57) ABSTRACT

The present invention relates to a composition containing polycarbonate and 0.01 wt. % to less than 0.30 wt. % of polyol, polyether polyol, or combinations thereof.

### RELATED APPLICATIONS

This application claims benefit to German Patent Application No. 10 2009 052363.4, filed Nov. 7, 2009, which is incorporated herein by reference in its entirety for all useful purposes.

### BACKGROUND OF THE INVENTION

The present invention relates to compositions containing polycarbonate and at least one polyol and having improved optical properties.

Transparent plastic moulding compositions having high transmission and low haze are used for many applications, for example for the production of spectacle lenses or plastic headlamp diffusers, these being preferably manufactured by injection moulding. These plastic moulding compositions are also used in automotive glazing systems, which can be manufactured by either injection moulding or extrusion methods. A further area of application for these plastic moulding compositions is in the production of transparent architectural glazing systems.

Haze in these materials causes the view through moulding compositions produced from these materials, e.g. glazing systems or spectacle lenses, to be adversely affected in an undesirable manner, and the haze effect increases exponentially with the thickness of the material. The transparent, melt processable compositions in materials for producing glazing systems or optical instruments are therefore required to have the lowest possible haze and the highest possible transmission, and many research projects in the past have focused on improving these properties.

JP-A 02-202544 describes polycarbonate compositions containing 0.1 wt. % of potassium diphenyl sulfonate and 0.3 wt. % of polyethylene glycol with a molecular weight of 600 or 3400 (see examples), it being expressly stated that the transparency of compositions containing polyalkylene glycol with a molecular weight of greater than 1000 decreases.

WO 2000/52098 describes thermoplastic compositions which contain a thermoplastic resin selected from the group comprising cyclo-olefin polymers, polycyclohexane resins and 4-methyl-1-pentene polymers, have a content of less than 20 wt. % of aromatic rings and contain a polyhydric alcohol having at least 6 C atoms with a ratio of C atoms to hydroxyl groups of 1.5 to 30, wherein with a film thickness of 3 mm the haze is less than 10% and the transmission is greater than 80.

EP 680 996 describes thermoplastic resins having improved optical properties through the addition of optical brighteners based on benzoxazolyl.

Flame-resistant polycarbonate compositions with polyols are known from DE 10 2007 052 783 A1 which contain polycarbonate, polyol and an alkali or alkaline-earth salt of an aliphatic or aromatic sulfonic acid, sulfonamide or sulfonimide. The object of DE 10 2007 052 783 A1 was to provide transparent compositions having a markedly improved flame resistance with wall thicknesses of ≦3 mm. An influence of the polyols on the improvement of the optical properties of the compositions was neither disclosed nor suggested in the application, however.

Despite all previous efforts, there is still a need for polycarbonate compositions having improved transmission and reduced haze, in particular for the production of injection-moulded, unpainted products. This is particularly true of transparent compositions or transparent products intended for use in the production of glazing systems and optical instruments and components.

### BRIEF DESCRIPTION OF THE INVENTION

An embodiment of the present invention is a composition comprising:
a) a polycarbonate and
b) 0.01 wt. % to less than 0.30 wt. % of polyol, polyether polyol, or combinations thereof.

Another embodiment of the present invention is the above composition where the proportion of polyol, polyether polyols, or combinations thereof is 0.05 wt. % to 0.28 wt. %.

Another embodiment of the present invention is the above composition where the proportion of polyol, polyether polyol, or combinations thereof is 0.06 wt. % to 0.27 wt. %.

Another embodiment of the present invention is the above composition where proportion of polyol, polyether polyol, or combinations thereof is 0.10 wt. % to 0.25 wt. %.

Another embodiment of the present invention is the above composition where the polyol, polyether polyol, or combinations thereof has a molecular weight of 1100 to 20,000.

Another embodiment of the present invention is the above composition where the polyol, polyether polyol, or combinations thereof has a molecular weight of 2500 to 3500.

Another embodiment of the present invention is the above composition where the polyol is a polyether polyol.

Another embodiment of the present invention is the above composition where the polyether polyol is a polyalkylene polyol having 2 to 4 carbon atoms in the alkylene.

Another embodiment of the present invention is the above composition where the polyether polyol is polyethylene glycol, polypropylene glycol or polytetrahydrofuran.

Another embodiment of the present invention is the above composition where the polyol is polytetrahydrofuran.

Another embodiment of the present invention is the above composition where polycarbonate has an average molecular weight M̅_{w} of 16,000 to 40,000 g/mol.

Another embodiment of the present invention is the above composition where the composition further comprises at least one additive selected from the group consisting of fillers, UV stabilizers, heat stabilizers, antistatic agents, pigments, release agents and flow control agents.

Another embodiment of the present invention is the above composition comprising
a) 95.00 wt. % of polycarbonate having a melt volume-flow rate as defined in ISO 1133 of 9.5 cm³/10 min at 300° C. and under a load of 1.2 kg;
b) 4.75 wt. % to 4.95 wt. % of polycarbonate having a melt volume-flow rate as defined in ISO 1133 of 6.0 cm³/10 min at 300° C. and under a load of 1.2 kg; and
c) 0.05 wt. % to 0.25 wt. % of polytetrahydrofuran having an average molecular weight of 2900.

Yet another embodiment of the present invention is a product comprising the above composition.

Another embodiment of the present invention is the product above that is produced by injection moulding.

Yet another embodiment of the present invention is a process for producing the transparent thermoplastic compositions above, comprising:
a) producing a mixture of a polycarbonate solution with at least one polyol,
b) removing a solvent from the mixture after a), and
c) extruding the mixture from step b) with a further polycarbonate at a temperature of 280 to 330° C.

Another embodiment of the present invention is the process above further comprising adding additives to the mixture in step a).

Another embodiment of the present invention is the process above further comprising removing a solvent from the mixture after the addition of additives.

Yet another embodiment of the present invention is a process for the production of an injection-moulded product which comprises incorporating the composition above into the injection-moulded product.

Another embodiment of the present invention is the process above where the injection-moulded product is an unpainted product, a glazing system, an optical instrument, or components thereof.

### DETAILED DESCRIPTION OF THE INVENTION

The object of the present invention was therefore to provide transparent polycarbonate compositions having markedly improved transmission and reduced haze, as well as processes for their production and mouldings produced from the compositions.

Surprisingly it was found that compositions according to claim 1 of the present invention, which contain polycarbonate and small amounts of polyol, have excellent properties in terms of elevated transmission, particularly in the case of polyols with a molecular weight greater than 1000 and a low overall concentration of polyol.

The present invention therefore relates to compositions containing polycarbonate and 0.01 wt. % to less than 0.30 wt. % of polyol, the polyol preferably having a molecular weight greater than 1000.

The present invention also relates to a process for producing a composition according to the invention in which the polycarbonate and at least one polyol are brought together and mixed.

The compositions according to the invention contain no flame retardants.

In a preferred embodiment at least one component of the mixture is dissolved in a solvent which is removed again after mixing, wherein the mixture can additionally be homogenised before removing the solvent.

The polymer compound thus obtained can be pelletised in a next step and processed directly into mouldings.

Polycarbonates for the compositions according to the invention are homopolycarbonates, copolycarbonates and thermoplastic, preferably aromatic, polyester carbonates, which in the present application are subsumed under the term “polycarbonate”.

The homopolycarbonates, copolycarbonates and polyester carbonates according to the invention generally have average molecular weights (weight average) of 2000 to 200,000, preferably 3000 to 150,000, more preferably 5000 to 100,000, even more preferably 8000 to 80,000, particularly preferably 12,000 to 70,000 (determined by GPC with polycarbonate calibration), and most preferably average molecular weights M̅_{w} of 16,000 to 40,000 g/mol.

Regarding the production of polycarbonates for the compositions according to the invention reference is made here by way of example to Schnell, “Chemistry and Physics of Polycarbonates”, Polymer Reviews, Vol. 9, Interscience Publishers, New York, London, Sydney 1964, to D. C. PREVORSEK, B. T. DEBONA and Y. KESTEN, Corporate Research Center, Allied Chemical Corporation, Morristown, N.J. 07960, “Synthesis of Poly(ester)carbonate Copolymers” in Journal of Polymer Science, Polymer Chemistry Edition, Vol. 19, 75-90 (1980), to D. Freitag, U. Grigo, P. R. Müller, N. Nouvertne, BAYER AG, “Polycarbonates” in Encyclopedia of Polymer Science and Engineering, Vol. 11, Second Edition, 1988, pages 648-718, and finally to Drs. U. Grigo, K. Kircher and P. R. Müller, “Polycarbonate” in Becker/Braun, Kunststoff-Handbuch, Vol. 3/1, Polycarbonate, Polyacetale, Polyester, Celluloseester, Carl Hanser Verlag Munich, Vienna 1992, pages 117-299. Production preferably takes place by the interfacial polycondensation process or the melt interesterification process and is described first by reference to the interfacial polycondensation process by way of example.

Preferred compounds to be used as starting compounds are bisphenols of the general formula (1)

HO—Z—OH (1)

in which Z is a divalent organic radical having 6 to 30 carbon atoms and containing one or more aromatic groups.

Z in formula (1) preferably denotes a radical of formula (1a)

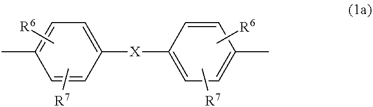

in which
R⁶ and R⁷ independently of each other denote H, C₁-C₁₈ alkyl, C₁-C₁₈ alkoxy, halogen such as Cl or Br or optionally substituted aryl or aralkyl, preferably H or C₁-C₁₂ alkyl, particularly preferably H or C₁-C₈ alkyl and most particularly preferably H or methyl, and
X denotes a single bond, —SO₂—, —CO—, —O—, —S—, C₁ to C₆ alkylene, C₂ to C₅ alkylidene or C₅ to C₆ cycloalkylidene, which can be substituted with C₁ to C₆ alkyl, preferably methyl or ethyl, also C₆ to C₁₂ arylene, which can optionally be fused to other aromatic rings containing heteroatoms.
X preferably denotes a single bond, C₁ to C₅ alkylene, C₂ to C₅ alkylidene, C₅ to C₆ cycloalkylidene, —O—, —SO—, —CO—, —S—, —SO₂—,
   or a radical of formula (1b) or (1c)

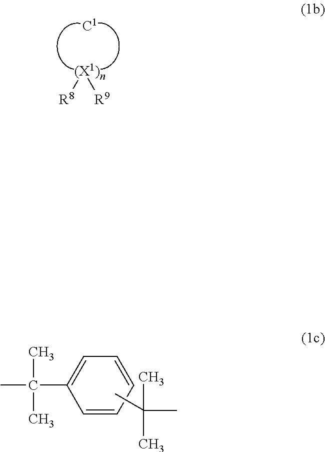

in which
R⁸ and R⁹ can be selected individually for each X¹ and independently of each another denote hydrogen or C₁ to C₆ alkyl, preferably hydrogen, methyl or ethyl, and
X¹ denotes carbon and
n denotes a whole number from 4 to 7, preferably 4 or 5, with the proviso that on at least one X¹ atom R⁸ and R⁹ are both alkyl.

Examples of such compounds are bisphenols belonging to the group of dihydroxydiphenyls, bis(hydroxyphenyl)alkanes, indane bisphenols, bis(hydroxyphenyl)ethers, bis(hydroxyphenyl)sulfones, bis(hydroxyphenyl)ketones and α,α′-bis(hydroxyphenyl) diisopropylbenzenes.

Particularly preferred bisphenols belonging to the aforementioned groups of compounds are bisphenol A, tetraalkylbisphenol A, 4,4-(meta-phenylene diisopropyl)diphenol (bisphenol M), 4,4-(para-phenylene diisopropyl)diphenol, N-phenyl isatin bisphenol, 1,1-bis-(4-hydroxyphenyl)-3,3,5-trimethylcyclohexane (BP-TMC), bisphenols of the 2-hydrocarbyl-3,3-bis-(4-hydroxyaryl)phthalimidine type, in particular 2-phenyl-3,3-bis-(4-hydroxyphenyl)phthalimidine, and optionally mixtures thereof.

Homopolycarbonates based on bisphenol A and copolycarbonates based on the monomers bisphenol A and 1,1-bis-(4-hydroxyphenyl)-3,3,5-trimethylcyclohexane are particularly preferred. The bisphenol compounds for use according to the invention are reacted with carbonic acid compounds, in particular phosgene, or, in the melt interesterification process, with diphenyl carbonate or dimethyl carbonate.

Polyester carbonates are obtained by reacting the already cited bisphenols, at least one aromatic dicarboxylic acid and optionally carbonic acid equivalents. Suitable aromatic dicarboxylic acids are for example phthalic acid, terephthalic acid, isophthalic acid, 3,3′- or 4,4′-diphenyldicarboxylic acid and benzophenone dicarboxylic acids. A part, up to 80 mol %, preferably from 20 to 50 mol %, of the carbonate groups in the polycarbonates can be replaced by aromatic dicarboxylic acid ester groups.

Inert organic solvents used in the interfacial polycondensation process are for example dichloromethane, the various dichloroethanes and chloropropane compounds, tetrachloromethane, trichloromethane, chlorobenzene and chlorotoluene. Chlorobenzene or dichloromethane or mixtures of dichloromethane and chlorobenzene are preferably used.

The interfacial polycondensation reaction can be accelerated by means of catalysts such as tertiary amines, in particular N-alkyl piperidines or onium salts. Tributylamine, triethylamine and N-ethylpiperidine are preferably used. In the case of the melt interesterification process the catalysts cited in DE-A 42 38 123 are used.

The polycarbonates can be branched in an intentional and controlled manner through the use of small amounts of branching agents. Some suitable branching agents are: isatin bis-cresol, phloroglucinol, 4,6-dimethyl-2,4,6-tri-(4-hydroxyphenyl) heptene-2; 4,6-dimethyl-2,4,6-tri-(4-hydroxyphenyl) heptane; 1,3,5-tri-(4-hydroxyphenyl)benzene; 1,1,1-tri-(4-hydroxyphenyl)ethane; tri-(4-hydroxyphenyl)phenylmethane; 2,2-bis-[4,4-bis-(4-hydroxyphenyl)cyclohexyl]propane; 2,4-bis-(4-hydroxyphenyl isopropyl)phenol; 2,6-bis-(2-hydroxy-5′-methylbenzyl)-4-methylphenol; 2-(4-hydroxyphenyl)-2-(2,4-dihydroxyphenyl) propane; hexa-(4-(4-hydroxyphenyl isopropyl)phenyl) ortho-terephthalic acid ester; tetra-(4-hydroxyphenyl)methane; tetra-(4-(4-hydroxyphenyl isopropyl)phenoxy)methane; α,α′,α″-tris-(4-hydroxyphenyl)-1,3,5-triisopropylbenzene; 2,4-dihydroxybenzoic acid; trimesic acid; cyanuric chloride; 3,3-bis-(3-methyl-4-hydroxyphenyl)-2-oxo-2,3-dihydroindole; 1,4-bis-(4′,4″-dihydroxytriphenyl)methyl)benzene and in particular: 1,1,1-tri-(4-hydroxyphenyl)ethane and bis-(3-methyl-4-hydroxyphenyl)-2-oxo-2,3-dihydroindole.

The 0.05 to 2.00 mol %, relative to diphenols used, of branching agents or mixtures of branching agents which can optionally be used can be used together with the diphenols or also added at a later stage of the synthesis.

Chain terminators can be used. Phenols such as phenol, alkyl phenols such as cresol and 4-tert-butyl phenol, chlorophenol, bromophenol, cumyl phenol or mixtures thereof, in amounts of 1-20 mol %, preferably 2-10 mol %, per mol of bisphenol, are preferably used as chain terminators. Phenol, 4-tert-butyl phenol and cumyl phenol are preferred.

Chain terminators and branching agents can be added to the synthesis separately or together with the bisphenol.

The preferred polycarbonate according to the invention is bisphenol A homopolycarbonate.

The polycarbonates according to the invention can also be produced by the melt interesterification process as an alternative. The melt interesterification process is described for example in Encyclopedia of Polymer Science, Vol. 10 (1969), Chemistry and Physics of Polycarbonates, Polymer Reviews, H. Schnell, Vol. 9, John Wiley and Sons, Inc. (1964) and DE-B 10 31 512.

In the melt interesterification process the aromatic dihydroxy compounds already described in connection with the interfacial polycondensation process are interesterified in the melt with carbonic acid diesters with the aid of suitable catalysts and optionally further additives.

Carbonic acid diesters within the meaning of the invention are those of formulae (2) and (3)

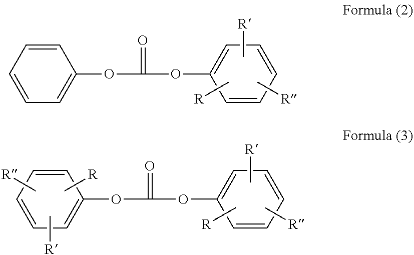

in which
R, R′ and R″ can independently of one another denote H, optionally branched C₁-C₃₄ alkyl/cycloalkyl, C₇-C₃₄ alkaryl or C₆-C₃₄ aryl,
for example
diphenyl carbonate, butylphenyl phenyl carbonate, dibutylphenyl carbonate, isobutylphenyl phenyl carbonate, diisobutylphenyl carbonate, tert-butylphenyl phenyl carbonate, di-tert-butylphenyl carbonate, n-pentylphenyl phenyl carbonate, di-(n-pentylphenyl) carbonate, n-hexylphenyl phenyl carbonate, di-(n-hexylphenyl) carbonate, cyclohexylphenyl phenyl carbonate, dicyclohexylphenyl carbonate, phenylphenol phenyl carbonate, diphenylphenol carbonate, isooctylphenyl phenyl carbonate, diisooctylphenyl carbonate, n-nonylphenyl phenyl carbonate, di-(n-nonylphenyl) carbonate, cumylphenyl phenyl carbonate, dicumylphenyl carbonate, naphthylphenyl phenyl carbonate, dinaphthyl phenyl carbonate, di-tert-butylphenyl phenyl carbonate, di-(di-tert-butylphenyl) carbonate, dicumylphenyl phenyl carbonate, di-(dicumylphenyl) carbonate, 4-phenoxyphenyl phenyl carbonate, di-(4-phenoxyphenyl) carbonate, 3-pentadecylphenyl phenyl carbonate, di-(3-pentadecylphenyl) carbonate, tritylphenyl phenyl carbonate, ditritylphenyl carbonate,
preferably
diphenyl carbonate, tert-butylphenyl phenyl carbonate, di-tert-butylphenyl carbonate, phenylphenol phenyl carbonate, diphenylphenol carbonate, cumylphenyl phenyl carbonate, dicumylphenyl carbonate, particularly preferably diphenyl carbonate.

Mixtures of the cited carbonic acid diesters can also be used.

The proportion of carbonic acid esters is 100 to 130 mol %, preferably 103 to 120 mol %, particularly preferably 103 to 109 mol %, relative to the dihydroxy compound.

Basic catalysts, such as for example alkali and alkaline-earth hydroxides and oxides but also ammonium or phosphonium salts, hereinafter referred to as onium salts, as described in the cited literature are used in the melt interesterification process as catalysts within the meaning of the invention. Onium salts are preferably used here, particularly preferably phosphonium salts. Phosphonium salts within the meaning of the invention are those of formula (4)

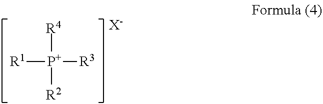

in which
R¹⁻⁴ can be identical or different C₁-C₁₀ alkyls, C₆-C₁₀ aryls, C₇-C₁₀ aralkyls or C₅-C₆ cycloalkyls, preferably methyl, or C₆-C₁₄ aryls, particularly preferably methyl or phenyl, and
X⁻ can be an anion such as hydroxide, sulfate, hydrogen sulfate, hydrogen carbonate, carbonate, a halide, preferably chloride, or an alcoholate of the formula OR, in which R can be C₆-C₁₄ aryl or C₇-C₁₂ aralkyl, preferably phenyl.

Preferred catalysts are tetraphenyl phosphonium chloride, tetraphenyl phosphonium hydroxide, tetraphenyl phosphonium phenolate, and particularly preferably tetraphenyl phosphonium phenolate.

The catalysts are preferably used in amounts from 10⁻⁸ to 10⁻³ mol, relative to one mol of bisphenol, particularly preferably in amounts from 10⁻⁷ to 10⁻⁴ mol.

Further catalysts can be used alone or optionally in addition to the onium salt to increase the rate of polymerization. These include salts of alkali metals and alkaline-earth metals, such as hydroxides, alkoxides and aryloxides of lithium, sodium and potassium, preferably hydroxide, alkoxide or aryloxide salts of sodium. Sodium hydroxide and sodium phenolate are most preferred.

The amounts of co-catalyst can be in the range from 1 to 200 ppb, preferably 5 to 150 ppb and most preferably 10 to 125 ppb, calculated in each case as sodium.

The interesterification reaction of the aromatic dihydroxy compound and the carbonic acid diester in the melt is preferably performed in two stages. In the first stage the aromatic dihydroxy compound and the carbonic acid diester are melted at temperatures of 80 to 250° C., preferably 100 to 230° C., particularly preferably 120 to 190° C., under normal pressure in 0 to 5 hours, preferably 0.25 to 3 hours. After adding the catalyst the oligocarbonate is produced from the aromatic dihydroxy compound and the carbonic acid diester by applying a vacuum (up to a pressure of 2.6 mbar in the apparatus) and raising the temperature (to up to 260° C.) by distilling off the monophenol. Most of it is formed as process vapours. The oligocarbonate produced in this way has a weight-average molecular weight Mw (determined by measuring the relative solution viscosity in dichloromethane or in mixtures of equal amounts by weight of phenol/o-dichlorobenzene, calibrated by light scattering) in the range from 2000 g/mol to 18,000 g/mol, preferably 4000 g/mol to 15,000 g/mol.

In the second stage the polycarbonate is produced by polycondensation by further increasing the temperature to 250 to 320° C., preferably 270 to 295° C., under a pressure less than 2.6 mbar, the residual process vapours being removed.

The catalysts can also be used in combination (two or more) with one another.

If alkali metal/alkaline-earth metal catalysts are used, the alkali metal/alkaline-earth metal catalysts are preferably added later on (for example after oligocarbonate synthesis during polycondensation in the second stage).

Within the meaning of the process according to the invention the reaction of the aromatic dihydroxy compound and the carbonic acid diester to the polycarbonate can be performed batchwise or preferably continuously, for example in stirred-tank reactors, film evaporators, falling-film evaporators, series of stirred-tank reactors, extruders, compounders, simple disc reactors and high-viscosity disc reactors.

Branched polycarbonates or copolycarbonates can be produced by using polyfunctional compounds, in an analogous manner to the interfacial polycondensation process.

Further aromatic polycarbonates can also be added to the polycarbonates according to the invention, for example by compounding.

Conventional additives for these thermoplastics, such as fillers, UV stabilizers, heat stabilizers, antistatic agents and pigments, can also be added in the conventional quantities to the polycarbonates according to the invention and to the further plastics which are optionally included; the demoulding behaviour and/or flow properties can optionally also be improved by the addition of external release agents and/or flow control agents (e.g. alkyl and aryl phosphites, phosphates, phosphanes, low-molecular-weight carboxylic acid esters, halo compounds, salts, chalk, silica flour, glass and carbon fibres, pigments and combinations thereof). Heat stabilizers such as by way of example and preferably tris-(2,4-di-tert-butylphenyl)phosphate or triphenylphosphine are preferably added in an amount of 10 to 3000 ppm, relative to the overall composition.

Such compounds are described for example in WO 99/55772 A1, p. 15-25, EP 1 308 084 and in the corresponding chapters of “Plastics Additives Handbook”, ed. Hans Zweifel, 5^{th} Edition 2000, Hanser Publishers, Munich.

Polyols within the context of the present invention are those having number-average molecular weights of 1100 to 20,000, preferably 1200 to 8000, particularly preferably 1500 to 7500, most particularly preferably 2000 to 7000, and more preferably from 2500 to 6000.

In a further preferred embodiment polyols having an average molecular weight of 2500 to 3500 are preferred.

The functionality of the polyols is 1.5 to 8.0, preferably 2.0 to 4.0, the functionality being defined as the average number of hydroxyl groups.

The polytetrahydrofuran homopolymer Terathane® 2900 (M_{w}=2900) from Du Pont is suitable as a commercial product, for example. Suitable polyether polyols are also block copolymers and copolymers having an irregular sequence of chain segments and mixtures of polyether polyols.

Polyether polyols can be produced by known methods, for example by anionic polymerisation of alkylene oxides in the presence of alkali hydroxides or alkali alcoholates as catalysts and with addition of at least one starter molecule containing reactive hydrogen atoms, or by cationic polymerisation of alkylene oxides in the presence of Lewis acids such as antimony pentachloride or boron fluoride etherate, or by double metal cyanide (DMC) catalysis. Suitable alkylene oxides contain 2 to 4 carbon atoms in the alkylene radical. Examples are tetrahydrofuran, 1,2-propylene oxide, 1,2- or 2,3-butylene oxide. The alkylene oxides can be used individually, alternating one after another, or as mixtures. Water or dihydric and trihydric alcohols, such as ethylene glycol, 1,2-propanediol and 1,3-propanediol, diethylene glycol, dipropylene glycol, ethanediol-1,4, glycerol, trimethylolpropane, etc., are suitable as the starter molecule.

Also suitable as polyether polyols are polymer-modified polyether polyols, preferably graft polyether polyols, in particular those based on styrene and/or acrylonitrile, which can be obtained in situ by polymerisation of acrylonitrile, styrene or preferably mixtures of styrene and acrylonitrile.

The polyesters, polyacetals, polycarbonates and polyester amides having at least two, preferably two to four hydroxyl groups and generally a number-average molecular weight of 1200 to 8000 can be used as further polyols, the homologous polythioethers being used in a particular embodiment.

The bifunctional polyether derivatives can be a homopolymer, a block copolymer or a copolymer having an irregular sequence of chain segments. Mixtures of polyesters and polyethers can of course be used.

Preferred polyether polyols are polyethylene glycol, polypropylene glycol and polytetrahydrofuran, polytetrahydrofuran being particularly preferred.

Within the context of the present invention the cited polyols can be used both alone and as mixtures of various polyols. The proportion of polyol or polyols in the compositions according to the invention is 0.01 wt. % to less than 0.30 wt. %, preferably 0.05 wt. % to 0.28 wt. %, more preferably 0.06 wt. % to 0.27 wt. %, and particularly preferably 0.10 to 0.25 wt. %, relative in each case to the overall composition. A polyol content of 0.25 wt. % is particularly preferred.

### Production of the Compositions:

Production of a composition containing polycarbonate and at least one polyol takes place with conventional mixing processes and can take place for example by mixing solutions of the polyol with a solution of polycarbonate in suitable solvents such as dichloromethane, haloalkanes, halogen aromatics, chlorobenzene and xylenes, the mixtures of solutions then optionally being homogenised and in a next step processed in a known manner by evaporation of the solvent and subsequent extrusion. Processing preferably takes place in an evaporating extruder.

In an alternative embodiment the components are used as solids and homogenised in a known manner by extrusion. To this end the components of the compositions are mixed in conventional mixing devices such as extruders (for example twin-screw extruders), compounders, Brabender or Banbury mills, and then extruded. Following extrusion the extrudate can be cooled and shredded.

In a further preferred embodiment individual components are premixed and then the remaining starting materials are added individually and/or likewise in a mixture.

The compositions according to the invention can be processed in a known manner and converted into any type of mouldings, for example by extrusion, injection moulding or extrusion blow moulding.

In the production of sheets according to the present invention the polycarbonate pellets of the base material are fed to the feed hopper of the main extruder and the coextrusion material to that of the coextruder. Each material is melted and transported in the respective cylinder/screw plasticising system. The two material melts are brought together in the coex adapter and after leaving the nozzle and being cooled they form a composite. The additional equipment serves to transport, cut to length and stack the extruded sheets.

Sheets without a coextruded layer are produced in the corresponding manner, either by not running the coextruder or by filling it with the same polymer composition as the main extruder.

Blow moulding of polycarbonate is described in more detail inter alia in DE 102 29 594 and in the literature cited therein.

All the references described above are incorporated by reference in their entireties for all useful purposes.

While there is shown and described certain specific structures embodying the invention, it will be manifest to those skilled in the art that various modifications and rearrangements of the parts may be made without departing from the spirit and scope of the underlying inventive concept and that the same is not limited to the particular forms herein shown and described.

### EXAMPLES

### Optical Measurements

The haze and transmission were measured on sheets measuring 60×40×4 mm³ in accordance with ISO 13468.

The yellowness index (YI) is calculated in accordance with ASTM E313.

### Molecular Weight Determinations:

The average molecular weight is determined by gel permeation chromatography (GPC) with a calibrated standard.

### Production of the Compositions:

The compositions in the examples and comparative examples 1 to 16 are produced by adding 5 wt. % of a powder mixture consisting of Makrolon® 3108 powder containing the substances specified in the examples to 95 wt. % of Makrolon® pellets to produce the compositions specified in the examples.

The compositions according to the present invention are compounded in a device comprising a metering unit for the components, a co-rotating twin-screw compounder (ZSK 25 from Werner & Pfleiderer) having a screw diameter of 25 mm, a perforated nozzle for extruding the melt strands, a water bath for cooling and solidifying the strands, and a pelletiser.

For the production of the compositions of the examples and comparative examples 1 to 16 in the compounding equipment described above, the following components were used:

### PC A:

Polycarbonate (pellets): polycarbonate (based on bisphenol A). The melt volume-flow rate (MVR) as defined in ISO 1133 is 9.5 cm³/(10 min) at 300° C. and under a load of 1.2 kg. (Makrolon® 2808, colour 000000, from Bayer MaterialScience AG).

### PC A1:

Polycarbonate (pellets): polycarbonate (based on bisphenol A). The melt volume-flow rate (MVR) as defined in ISO 1133 is 9.5 cm³/(10 min) at 300° C. and under a load of 1.2 kg. (Makrolon® 2808, colour 000000, from Bayer MaterialScience AG).

(PC A and PC A1 are identical polycarbonates from different production batches)

### PC B:

Polycarbonate (pellets): polycarbonate (based on bisphenol A). The melt volume-flow rate (MVR) as defined in ISO 1133 is 6.0 cm³/(10 min) at 300° C. and under a load of 1.2 kg. (Makrolon® 3108, colour 000000, from Bayer MaterialScience AG).

### PC B1:

Polycarbonate (pellets): polycarbonate (based on bisphenol A). The melt volume-flow rate (MVR) as defined in ISO 1133 is 6.0 cm³/(10 min) at 300° C. and under a load of 1.2 kg. (Makrolon® 3108, colour 550115, from Bayer MaterialScience AG).

### PC C:

Polycarbonate (pellets): polycarbonate (based on bisphenol A). The melt volume-flow rate (MVR) as defined in ISO 1133 is 19.0 cm³/(10 min) at 300° C. and under a load of 1.2 kg. (Makrolon® 2408, colour 000000, from Bayer MaterialScience AG).

### PC D:

Polycarbonate (pellets): polycarbonate (based on bisphenol A). The melt volume-flow rate (MVR) as defined in ISO 1133 is 12.5 cm³/(10 min) at 300° C. and under a load of 1.2 kg. (Makrolon® AL2647, colour 000000, from Bayer MaterialScience AG).

### PC E:

Polycarbonate (pellets): polycarbonate (based on bisphenol A). The melt volume-flow rate (MVR) as defined in ISO 1133 is 6.0 cm³/(10 min) at 300° C. and under a load of 1.2 kg. (Makrolon® 3108, colour 000000, from Bayer MaterialScience AG).

### PTHF:

Polytetrahydrofuran with an average molecular weight of 2900 (Terathane® 2900 from Du Pont).

### PEG:

Polyethylene glycol with an average molecular weight of approx. 8000 (Aldrich).

### PPG:

Polypropylene glycol with an average molecular weight of approx. 3500 (Aldrich).

Table 1 below shows the optical properties “Transmission” and “YI” for the polycarbonate compositions according to the invention 2, 3, 5, 6, 7, 9, 10, 12, 14 and 16 in comparison to the corresponding comparative examples 1, 4, 8, 11, 13 and 15.

TABLE 1

| Composition | | | | | | | | |
|---|---|---|---|---|---|---|---|---|
| [wt. %] | CE 1 | Ex. 2 | Ex. 3 | CE 4 | Ex. 5 | Ex. 6 | Ex. 7 | CE 8 |
| PC A | 95 | 95 | 95 | | | | | |
| PC A1 | | | | | | | | |
| PC B | | | | 95 | 95 | 95 | 95 | |
| PC B1 | | | | | | | | |
| PC C | | | | | | | | 95 |
| PC D | | | | | | | | |
| PC E | 5 | 4.9 | 4.75 | 5 | 4.95 | 4.9 | 4.75 | 5 |
| PTHF | | 0.1 | 0.25 | | 0.05 | 0.1 | 0.25 | |
| PPG | | | | | | | | |
| PEG | | | | | | | | |
| Haze | 0.361 | 0.212 | 0.184 | 3.569 | 1.151 | 0.338 | 0.267 | 0.309 |
| Transmission | 88.82 | 89.17 | 89.30 | 83.70 | 85.06 | 85.43 | 85.53 | 88.62 |
| Yellowness | 2.87 | 2.43 | 1.97 | 2.01 | 1.43 | 1.12 | 0.36 | 1.44 |
| index | | | | | | | | |
| Composition | | Ex. | CE | Ex. | CE | Ex. | CE | Ex. |
| [wt. %] | Ex. 9 | 10 | 11 | 12 | 13 | 14 | 15 | 16 |
| PC A | | | | | | | | |
| PC A1 | | | | | 95 | 95 | | |
| PC B | | | | | | | | |
| PC B1 | | | | | | | 95 | 95 |
| PC C | 95 | 95 | | | | | | |
| PC D | | | 95 | 95 | | | | |
| PC E | 4.9 | | 5 | 4.9 | 5 | 4.9 | 5 | 4.75 |
| PTHF | 0.1 | 0.25 | | 0.1 | | | | |
| PPG | | | | | | 0.1 | | |
| PEG | | | | | | | | 0.25 |
| Haze | 0.211 | 0.158 | 1.345 | 0.343 | 0.260 | 0.250 | 0.320 | 0.290 |
| Transmission | 88.70 | 88.68 | 86.48 | 86.90 | 84.63 | 84.89 | 83.82 | 84.31 |
| Yellowness | 1.30 | 0.99 | 0.90 | 0.30 | 2.91 | 2.45 | 4.39 | 3.33 |
| index | | | | | | | | |

As Table 1 clearly shows, the optical properties of the compositions are markedly improved by the addition of polyols, even in a proportion of just 0.05 wt. % relative to the overall composition. While the yellowness index falls noticeably after addition of the polyol component, the transmission rises.

1. A composition comprising:
a) a polycarbonate and
b) 0.01 wt. % to less than 0.30 wt. % of polyol, polyether polyol, or combinations thereof.

2. The composition according to claim 1, wherein the proportion of polyol, polyether polyols, or combinations thereof is 0.05 wt. % to 0.28 wt. %.

3. The composition according to claim 2, wherein the proportion of polyol, polyether polyol, or combinations thereof is 0.06 wt. % to 0.27 wt. %.

4. The composition according to claim 3, wherein the proportion of polyol, polyether polyol, or combinations thereof is 0.10 wt. % to 0.25 wt. %.

5. The composition according to claim 1, wherein the polyol, polyether polyol, or combinations thereof has a molecular weight of 1100 to 20,000.

6. The composition according to claim 5, wherein the polyol, polyether polyol, or combinations thereof has a molecular weight of 2500 to 3500.

7. The composition according to claim 1, wherein the polyol is a polyether polyol.

8. The composition according to claim 7, wherein the polyether polyol is a polyalkylene polyol having 2 to 4 carbon atoms in the alkylene.

9. The composition according to claim 8, wherein the polyether polyol is polyethylene glycol, polypropylene glycol or polytetrahydrofuran.

10. The composition according to claim 8, wherein the polyol is polytetrahydrofuran.

11. The composition according to claim 1, wherein the polycarbonate has an average molecular weight M̅_{w} of 16,000 to 40,000 g/mol.

12. The composition according to claim 1, wherein the composition further comprises at least one additive selected from the group consisting of fillers, UV stabilizers, heat stabilizers, antistatic agents, pigments, release agents and flow control agents.

13. The composition according to claim 1, comprising
a) 95.00 wt. % of polycarbonate having a melt volume-flow rate as defined in ISO 1133 of 9.5 cm³/10 min at 300° C. and under a load of 1.2 kg;
b) 4.75 wt. % to 4.95 wt. % of polycarbonate having a melt volume-flow rate as defined in ISO 1133 of 6.0 cm³/10 min at 300° C. and under a load of 1.2 kg; and
c) 0.05 wt. % to 0.25 wt. % of polytetrahydrofuran having an average molecular weight of 2900.

14. A product comprising the composition according to claim 1.

15. The product according to claim 14, wherein the product is produced by injection moulding.

16. A process for producing transparent thermoplastic compositions according to claim 1, comprising:
a) producing a mixture of a polycarbonate solution with at least one polyol,
b) removing a solvent from the mixture after a), and
c) extruding the mixture from step b) with a further polycarbonate at a temperature of 280 to 330° C.

17. The process according to claim 16, further comprising adding additives to the mixture in step a).

18. The process according to claim 17, further comprising removing a solvent from the mixture after the addition of additives.

19. A process for the production of an injection-moulded product which comprises incorporating the composition of claim 1 into the injection-moulded product.

20. The process according to claim 19, wherein the injection-moulded product is an unpainted product, a glazing system, an optical instrument, or components thereof.
